(19) United States
(12) Patent Application Publication
(10) Pub. No.: US 2026/0267039 A1
(43) Pub. Date: Sep. 10, 2026

(54) HOLLOW PLASMONIC NANSTRUCTURES BUILD UP PLASMONIC METASURFACE

(71) Applicant: Sony Semiconductor Solutions Corporation, Atsugi-shi, Kanagawa (JP)

(72) Inventors: Nikolaus KNORR, Stuttgart (DE); Tzenka MITEVA, Stuttgart (DE); Aleksandr VASKIN, Stuttgart (DE); Paul Georg HEIMEL, Stuttgart (DE); Max STRAUSS, Stuttgart (DE); Berthold WEGNER, Stuttgart (DE)

(73) Assignee: Sony Semiconductor Solutions Corporation, Atsugi-shi, Kanagawa (JP)

(21) Appl. No.: 19/166,879

(22) PCT Filed: Jan. 31, 2024
(86) PCT No.: PCT/EP2024/052419

§ 371 Date: Sep. 19, 2025

(30) Foreign Application Priority Data
Mar. 31, 2023 (EP) 23166248.7

(51) Int. Cl. G02B 5/00; G02B 1/00

(52) U.S. Cl. CPC G02B 5/008; G02B 1/002

(57) ABSTRACT

A plasmonic metasurface comprising a plurality of metaatoms, the plasmonic metasurface comprising a nanostructured dielectric component and at least one ultrathin metal layer of one or more plasmonic metals conformal to the nanostructure to define resonances at designed wavelengths is disclosed herein.

### TECHNICAL FIELD

The present disclosure relates to the field of nanophotonics, in particular to plasmonic metasurfaces and semiconductor devices.

### TECHNICAL BACKGROUND

Metamaterials are engineered materials that interact with waves in a desired fashion. With metamaterials properties of the final product can be realized which are not possible with naturally occurring materials. Building blocks of the metamaterials are so-called meta-atoms, that are smaller than the wavelengths of desire. Metasurfaces are 2D metamaterials with a thickness below the wavelength of interest. They can be any arrangement in between, on the one hand, spatially highly inhomogeneous, with generally non-identical meta-atoms placed on a generally aperiodic lattice, and, on the other, essentially periodic with identical meta-atoms placed in a periodic lattice (including photonic crystal slab geometries). In general, the main distinguishing feature of metasurfaces as opposed to gratings and photonic crystals (both of their functions are defined by their periodic arrangements) is that metasurfaces dominantly inherit properties from their individual meta-atoms and their resonant properties.

Nanostructured thin metal layers of highly conductive metals form localized surface plasmon resonances when exposed to electromagnetic radiation. The characteristics of the plasmonic resonances and their sensitivity to the surrounding medium provides the potential for use in transparent electrodes applications, energy harvesting, imaging, color filtering, color conversion, optical processing, plasmon-enhanced fluorescence and other sensing applications. The plasmonic metasurface may especially be used in biosensing. Biosensing is based on resonance peak shift upon change of the refractive index on top of the plasmonic metasurface, referred to as analyte on the surface sensing. With a plasmonic metasurface the emission might be enhanced. E.g., in antibody-antigen based sensing based on dye emission variation, the emission of the dye will be enhanced and directed for higher sensitivity/dynamic range tuning. Metal-only defined plasmonics have limited tunability and high losses, even in the most recent published results, The fabrication of these metal only plasmonic nanophotonic systems is complex for mass production (electron beam lithography or nano-imprint lithography-based processes).

Dielectric emissive metasurfaces based on high refractive index elements have been shown to strongly increase the conversion efficiency and brightness of emitted light but are often not applicable at lower wavelengths due to strongly increasing absorption of the high refractive index materials such as silicon, that is typically used for such elements and have similar difficult for mass production fabrication processes.

Plasmonic metasurfaces are disclosed in Nature photonics 8, no. 12 (2014): 889-898.

Light-emitting metasurfaces are metasurfaces with nanoscale emitters such as quantum dots (QDs), dye molecules, or direct-bandgap semiconductors integrated into the metasurface architecture. The meta-atoms can be designed to act as nanoantennas that efficiently couple the emission from the excited metaatoms to the far-field, while imprinting the desired properties onto the emitted light field. To optimize the coupling between the nanoantennas and the emitters, the latter should be localized in optical near-fields of the nanoantennas. Light-emitting metasurfaces inherit most of the functionalities provided by optical nanoantennas, such as excitation enhancement and emission enhancement via the Purcell effect, as well as spectral and directional shaping of the emitted light. Emisisve metasurfaces are disclosed e.g., in Vaskin et al., Nanophotonics 2019, 8(7), 1151.

US 2019/0227431A1 discloses a photoresist resin composition including a plurality of quantum dots, a photopolymerizable monomer, a photopolymerization initiator, a scatterer, a binder resin and a solvent.

US 2021/0208308A1 discloses non-absorptive trans-reflective nanostructured RGB filters.

Fang et al. (https://doi.org/10.1063/5.0098286), discusses all-dielectric metasurface with ultrahigh color filtering and polarization-independent/dependent characteristics.

Nasehi et al., IJECE 2021, 4(18), 1399 disclose angle robust reflective subtractive color filter using titanium dioxide metasurface and aluminum mirrors.

### SUMMARY

According to a first aspect there is provided a plasmonic metasurface comprising a plurality of metaatoms, the plasmonic metasurface comprising a nanostructured dielectric component and at least one ultrathin metal layer of one or more plasmonic metals conformal to the nanostructure to define resonances at designed wavelengths.

In a further aspect there is provided a semiconductor device comprising the metasurface as described herein, the metasurface being configured for enhancement of absorption of a first color and emission of a second color.

Further, there is provided a method for preparing a plasmonic metasurface as disclosed herein, the method comprising the steps:
Providing a nanostructured plastic substrate by injection molding or hot embossing,
Optionally, coating the substrate with an adhesion layer,
Coating the substrate with an ultrathin plasmonic metal layer
Optionally, coating the ultrathin metal layer with dielectric layer for protection, spacing, or adhesion purposes.

### BRIEF DESCRIPTION OF THE DRAWINGS

Embodiments are explained by way of example with respect to the accompanying drawings, in which:

FIG. 1 shows an exemplary meta-atom.

FIG. 2 shows disks of a nanostructured substrate (203).

FIG. 3 shows a simulated transmission spectrum of an exemplary plasmonic metasurface.

FIG. 4 shows a simulated transmission spectrum of an exemplary plasmonic metasurface.

FIG. 5 shows the simulated transmission spectrum of a dielectric amorphous silicon nanodisk structured metasurface.

FIGS. 6a, b and c show scanning electron microscopies of suitable injection molded periodic nanostructures.

FIG. 7 is a schematic overview of a method for preparing a plasmonic metasurface (700).

FIG. 8 shows an exemplary meta-atom.

FIG. 9 shows the emission enhancement of an exemplary metasurface in reflection.

FIG. 10 shows the emission enhancement of an exemplary metasurface in transmission.

### DETAILED DESCRIPTION OF EMBODIMENTS

Before a detailed description of the embodiments under reference of the figures is given, general explanations are made.

The embodiments disclose a plasmonic metasurface comprising a plurality of metaatoms, the plasmonic metasurface comprising a nanostructured dielectric component and at least one ultrathin metal layer of one or more plasmonic metals conformal to the nanostructure to define resonances at designed wavelengths.

The electromagnetic field induced valence band electrons excitation in metals are named as the surface plasmon polaritons. Such electromagnetic surface waves arise through the coupling of the electromagnetic field to oscillation of the conductor's electron plasma. Taking advantage of strong light-matter interactions and unique properties, surface plasmons exhibit extensive applications and potential in light focusing, optical imaging, ultra-sensitive sensing, detection and medical therapy.

The plasmonic metal layer may have a thickness of <50 nm. Preferably, the plasmonic metal layer may have a thickness of <15 nm.

The plurality of metaatoms may be arranged such that they support at least one surface plasmon resonance.

The metaatoms may for example be arranged in a lattice. The lattice may for example be a square lattice, a hexagonal lattice, or the like.

The plurality of metaatoms may be arranged such that they support at least one lattice resonance mode and wherein the metaatoms have a size and shape such that they support at least one surface plasmon resonance.

The metaatom may have an irregular or regular shape. The shape may be selected from cylinders, oval shaped disks, truncated cones or pyramids, semi-spheres, or cuboids, all of them with or without rounded edges.

An additional adhesion layer (also revered to as “wetting layer” or “seed layer”) on top of the substrate may be applied for better film growth and adhesion of the ultrathin metal layer. The adhesion layer may be Al, Ti, Ge, Cu, and ZnS. It typically has a thickness below 5 nm.

The plasmonic metals may be selected from the group consisting of Ag, Au, Cu, Al, and Ti.

There are embodiments, wherein the plasmonic metal is Ag. The plasmonic metals may be responsible for localized surface plasmon resonances with high Q tunable by lattice (e.g., nano-lattice) geometries.

The metasurface may further comprise an emissive system.

In an embodiment, the nanostructured dielectric component in the metasurface is configured so that a first surface plasmon resonance mode of the metaatoms and a lattice resonance mode of the nanostructured dielectric component are matched to the emission frequency of the emissive system, and so that a second surface plasmon resonance mode of the metaatoms is matched to the absorption frequency of the emissive system.

A matching of lattice mode to surface plasmon resonance was derived by iterative lattice mode matching with the following lattice modes equations:

$$\frac{2 π}{λ} = \sqrt{{( \frac{2 π}{λ} sin θ cos ϕ + p \frac{2 π}{a} )}^{2} + {( \frac{2 π}{λ} sin θ sin ϕ + j \frac{2 π}{a} )}^{2}} \qquad ( 1 )$$

$$n \frac{2 π}{λ} = \sqrt{{( \frac{2 π}{λ} sin θ cos ϕ + l \frac{2 π}{a} )}^{2} + {( \frac{2 π}{λ} sin θ sin ϕ + m \frac{2 π}{a} )}^{2}} \qquad ( 2 )$$

The iterative matching of lattice mode to surface plasmon resonances may be done according to ACS Photonics 2018 (5), 1359 with the following steps:
1. Choose angles of incidence θ and φ
2. Choose diffraction orders (p, j, l, and m) (for chosen θ and φ with initial lattice period a) for close match of either one of the two equations.
3. Tune period a to satisfy the lattice mode equation completely.
4. Retune disc geometries using new a to have simulated Surface plasmon-resonance at chosen emission wavelength.

The emission frequency may for example relate to output light emitted by the emissive system and the absorption frequency may for example relate to input light absorbed by the emissive system.

The nanostructured dielectric component, the plasmonic metal layer, and the emissive system layer may be configured to resonantly enhance the absorption of the emissive system, e.g., at low wavelengths.

The geometry and dimensions of the nanostructured dielectric surface (and other additional layers) are configured so that it is possible to resonantly enhance the absorption of the emissive system at low wavelengths as well as its emission at longer wavelengths with overall low absorption losses.

In an embodiment, the nanostructured dielectric component, the plasmonic metal layer, and the emissive system layer are configured to perform emission with overall low absorption losses.

The nanostructured dielectric component, the plasmonic metal layer, and the emissive system may be configured to resonantly enhance the emission of the emissive system.

The plasmonic metasurface may be configured for color conversion in the visible spectrum. In this way, the metasurface may for example be applied as a LED color conversion filter. For example, the emissive system may be configured to provide a ternary or higher order emissive energy transfer system for efficient metasurface based color conversion. The metasurface may in particular provide an efficient wide wavelength gap color conversion. The plasmonic metasurface may for example be configured for up-conversion and/or down-conversion.

There are embodiments, wherein the plasmonic metasurface is configured for directional intensity control of incident and emitted light.

The emissive system is typically chosen to emit light of a desired wavelength.

The plasmonic metasurface with resonances in the visible and infrared may also be used in transparent electrodes applications, energy harvesting, imaging, color filtering, optical processing, plasmon-enhanced fluorescence, biosensors, and other sensing applications.

In an embodiment, the emissive system is located on top of the metal film by conformal coating.

The nanostructured dielectric component may comprise a dielectric material having a refractive index between 1.3 to 1.7. This allows a nanofabrication by injection molding or by any nanofabrication technic producing nanostructures with designed arrangements from dielectric materials. Exemplary materials are PE (polyethylene), PS (polystyrene), PMMA (poly methyl methacrylate), PC (polycarbonate), COC (cyclic olefin copolymer), PET (polyethylene terephthalate), and Nylons.

The individual shape, i.e., the metaatom, may be in nanometer size. Thus, it may have a size of between about 20 nm to about 500 nm. The size typically defines the broadest extension of the shape, i.e., the metaatom.

The dimensions of the metaatoms may be smaller than half of the freespace wavelength.

Preferably, Δx, Δy, Δz<λ₀/2, where λ₀ is the freespace wavelength, and where Δx, Δy, Δz are the dimensions of a metaatom. This may apply to emission and absorption wavelengths.

There are embodiments of the metasurface, wherein the emissive system is a ternary or higher order emissive system.

The emissive system may be a thin emissive system. The emissive system may have a thickness of about 10 nm. Thin emissive systems are preferred for uses in biosensing. Biosensing is based on a resonance peak shift upon change of the refractive index on top of the metasurface (analyte on the surface sensing). In combination with emission (e.g. antibody-antigen based sensing based on dye emission variation)—the emission of the emissive system (e.g., the dye) will be enhanced and directed for higher sensitivity/dynamic range tuning.

Fluorescence detection in biosensing offers numerous important advantages over other methods. Biorecognition is achieved by fluorescent probing using a variety of detectors. Emission enhancement (brightness, direction) nanophotonic systems provide the best opportunity to further improve sensitivity of emission-based biosensors.

There are existing high performance nanophotonic systems which already provide significant signal improvement of emission-based biosensors (up to >100× enhancement in selected conditions): Jeong, Y. et al., Biosens. Bioelectron., vol 111, 102-116, 2018, Badshah, M. A. et al., Nanomaterials, vol 10, no 9, 1749, 2020, Zhou et al, Anal. Chem. 2012, 84, 10, 4489-4495 and https://doi.org/10.1515/nanoph-2020-0270.

However, their design and design optimization are limited by metal-only defined plasmonics (limited tunability, losses). The fabrication of these nanophotonic systems is complex for mass production (electron beam lithography or nano-imprint lithography-based processes). Thus, plasmonic metasurfaces as described herein are versatile and tunable alternatives.

The emissive system may comprise at least one emissive component selected from the group consisting of an organic dye, chromophores, fluorophores, inorganic materials, and quantum dots.

In an embodiment, the emissive system is an organic dye. The dye may be a mixture of a chemical substance that chemically bonds to the substrate to which it is applied. Typical dyes are chemical substances that are solved in a solvent, such as water, or organic solvents. The day may be responsible for converting light of a certain first wavelength to light of a certain second wavelength.

Alternatively, the emissive system may comprise an inorganic material. In other words, the emissive system may comprise at least one inorganic molecule, or might consist of at least one inorganic molecule. The at least one inorganic molecule preferably converts light of a certain first wavelength to light of a certain second wavelength. Exemplary inorganic molecules might be quantum dots. An inorganic layer might comprise one type of quantum dots or might comprise a mixture of different quantum dots.

In a preferred embodiment, the at least one emissive system is a chromophore. that the emissive system might comprise at least one chromophore, or consists of a chromophore. The at least one chromophore preferably converts light of a certain first wavelength to light of a certain second wavelength. A chromophore is the part of a molecule, or the molecule itself that is responsible for the color. The chromophore(s) may be present as pure substances, or may be present in a suitable matrix.

Exemplary chromophores comprise a conjugated pi-system, such as fluorenes, spirofluorenes, spirobifluorenes, quinolines, naphthalines, and anthracenes.

A chromophore might be selected from the group consisting of 2,7-Bis(9,9-spirobifluoren-2-yl)-9,9-spirobifluorene (TSBF), (Z)-6-Mesityl-N-(6-mesitylquinolin-2(1H)-ylidene)quinolin-2-amine-BF₂ complex (MQAB), and 2,7-Bis(carbazol-9-yl)-9,9-spirobifluorene (Spiro-2CBP).

The emissive system may be configured for up-conversion and down-conversion.

In an embodiment, the emissive system comprises an emitter and an absorber mixed together in a matrix material.

The absorber and the emitter may be two different molecules. The acceptor may for example be acceptor chromophores and the emitter may for example be donor chromophores.

The emissive system may absorb and emit in the visible range.

The emitter and the acceptor may be selected so that the absorption and emission peaks of the emissive system are tuned to the resonances of the nanostructure.

By tuning of the concentrations of the emitter and acceptor in the emissive system, the efficiency of the energy transfer, the field distribution inside the emissive system, and the loss by reabsorption may be optimized. For example, donor chromophores may get excited at low wavelength and transfer energy to acceptor chromophores through non-radiative dipole-dipole coupling and the acceptor chromophore may emit at higher wavelength. The non-radiative dipole-dipole coupling may for example be caused by Forster or fluorescence resonance energy transfer (FRET). This may enhance the overall color conversion efficiency.

There are embodiments provided, wherein the effective refractive index of the emissive system is matched to the resonant nanostructure.

The refractive index n=n+ik of the emissive system at absorption wavelength may be n=2.0 at k=0.2, and the refractive index n=n+ik of the emissive system at emission wavelength may be n=1.8 at k=0.01.

The emissive layer might be separated by the dielectric layer, the ultrathin metal layer and the plastic or silica layer from the substrate.

The plasmonic metasurface may comprise additional layers. Exemplary additional top layers may be protection layers, spacing layers, planarization layer.

Furthermore, there is provided a method for preparing a metasurface as disclosed herein, the method comprising the steps:
Providing a nanostructured plastic substrate by injection molding or hot embossing,
Optionally, coating the substrate with an adhesion layer,
Coating the substrate with an ultrathin plasmonic metal layer
Optionally, coating the ultrathin metal layer with dielectric layer for protection, spacing, or adhesion purposes.

The adhesion layer may also be called seed or wetting layer. The adhesion layer may comprise, or may consist of Al, Ti, Ge, Cu, and ZnS. The adhesion layer may have a thickness of <5 nm. The method may further comprise the step applying an emissive system on the ultrathin metal layer or dielectric component. The emissive system may be deposited via vacuum deposition, spincoating, molecular beam deposition, etc.

In a first step of the method described herein, a nanostructured substrate is provided. Preferably, the substrate is a plastic nanostructured by injection molding or hot embossing. The substrate may be coated with an adhesion layer to improve the growth and adhesion of the ultrathin metal layer.

In a further step, the nanostructured substrate is coated with an ultrathin plasmonic metal layer.

The plasmonic metal layer corresponds to the plasmonic metal layer as described herein.

Further the ultrathin plasmonic metal layer may be coated with a dielectric layer for protection, spacing, or adhesion purposes.

Plasmonic metasurfaces as described herein allow a low-cost mass production. Structures may even have varied heights when fabrication method allows.

A further embodiment is a metasurface prepared by a method as described herein.

A further embodiment is a use of a metasurface as described herein in transparent electrodes applications, energy harvesting, imaging, color filtering, color conversion, optical processing, plasmon-enhanced fluorescence, and other sensing application, and especially biosensing.

The metasurface disclosed herein allows a strong enhancement of the light emission and a direction control of the emitted light.

As used herein the term “organic” is used in its generally understood meaning, i.e. it refers to compounds which are carbon-containing compounds. As it is used here, it also includes elemental carbon, at least in the form of fullerenes. The term “organic” is further meant to exclude specific carbon-containing compounds such as: hydrogen-free chalkogenides of carbon, e.g. CO, CO₂, CS₂, and derivatives thereof, e.g. H₂CO₃, KSCN; further excluded are salt-like carbides which are binary compounds of elements with carbon, which decompose to hydrocarbons under the influence of water or dilute acids. Salt-like carbides have the general formula M¹₂C₂ or M^{IIC}₂, wherein M^{I} or M^{II} denotes a metal ion with one or two valences. Salt-like carbides of calcium, silver and copper decompose to acetylene, the salt-like carbide of aluminum (Al₄C₃) decomposes to methane. Further excluded carbon-containing compound which do not form part of the term “organic” are metallic carbides, which are non-stoichiometric compounds having the character of an alloy. They are resistant to acids and are electrically conducting.

As used here a chromophore is the part of a molecule responsible for its color.

A fluorophore (or fluorochrome, similarly to a chromophore) is a fluorescent chemical compound that can re-emit light upon light excitation.

A phosphor is an emitter emitting phosphorescence. In phosphorescence the emitter does not reemit the radiation it absorbs with ion ps− to ns but in μs to s after the absorption of photon. Here organic or inorganic phosphors can be part of the emissive system.

Organic dye is a molecule which contains one or more chromophores/fluorophores or phosphores.

The organic dye can be a small molecule (up to 1000 Da) or a polymer.

Further the emitters can be inorganic phosphors or QDs

QD as used here are also called (semiconductor) nanocrystals, are semiconductor particles a few nanometers in size, having optical and electronic properties that differ from those of larger particles as a result of quantum mechanics. The nanocrystals can also be phosphors (or phosphorescent QDs).

The matrix as used here in the invention could consist of organic molecules/polymers or could be inorganic. Its main function is to ensure good distribution of the absorbing and the emitting components in the (at least) tri-components or ternary emissive systems.

The emissive system may contain a matrix, at least one chromophore, inorganic or hybrid absorber and at least one emitter (fluorophore or phosphor). The absorbing and the emitting chromophore can be combined in one organic dye/molecule.

In the context of the application, the near-field proximity of a component describes the region of space which is closer to the component than the free-space wavelength of the interacting light fields.

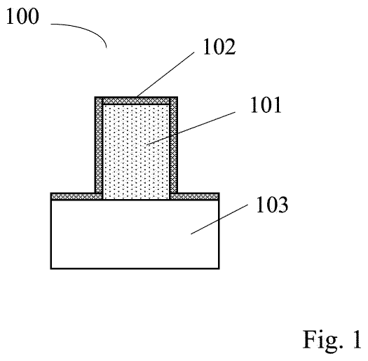

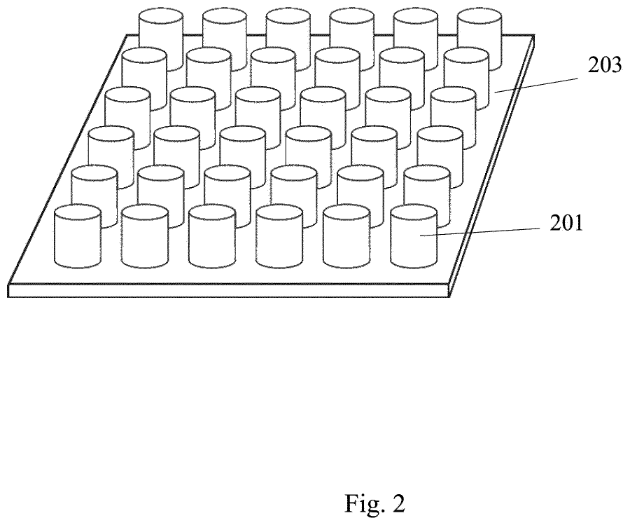

FIG. 1 shows an exemplary metaatom 100. The metaatom 100 comprises a nanostructured substrate 103, a plastic or silica layer 101 and a plasmonic metal layer 102. The plastic or silica layer 101 and the substrate 103 may be the same material.

FIG. 2 shows periodically arranged disks of a nanostructured substrate 203.

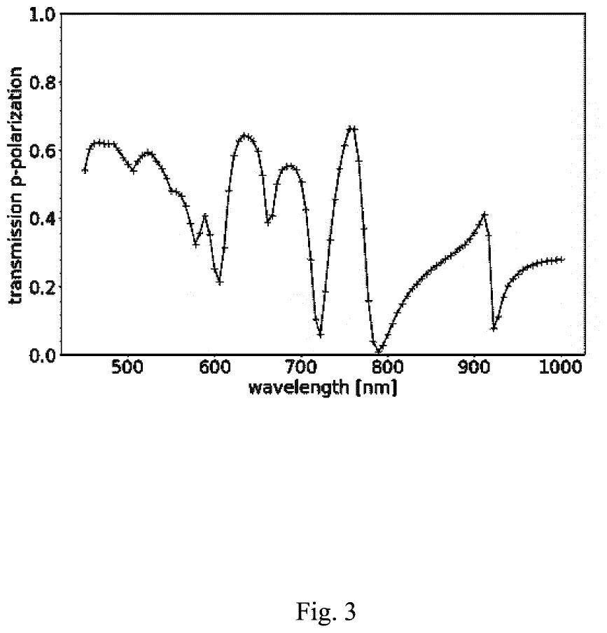

FIG. 3 shows the simulated transmission spectrum of an exemplary plasmonic metasurface with an ultrathin silver shell layer on top of a nanostructured plastic substrate. A meta-atom of the plasmonic metasurface corresponds to one depicted in FIG. 1. A conformal 10 nm thick Ag film is on top of a nanostructured substrate with a refractive index of n=1.59 substrate. The nanostructure is an infinite square lattice of nanodisks, with a disk height of 300 nm, a disk diameter of 140 nm, and a 450 nm period of the lattice. Strongly enhanced and reduced resonant transmission is observed at different wavelengths as compared to the transmission of un unstructured metal film o the same thickness on a planar substrate, due to the presence of localized surface plasmon resonance.

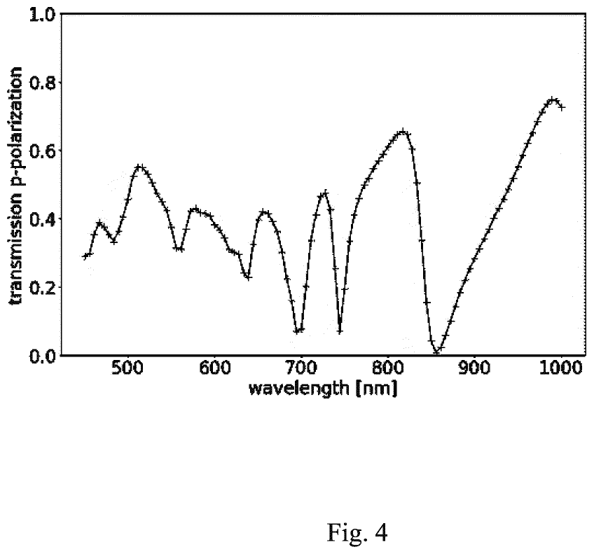

FIG. 4 shows the simulated transmission spectrum of the same structure as used in FIG. 3 but with exchanged nanodisk diameter of 240 nm. Resonances are shifted to different wavelengths as compared to FIG. 3.

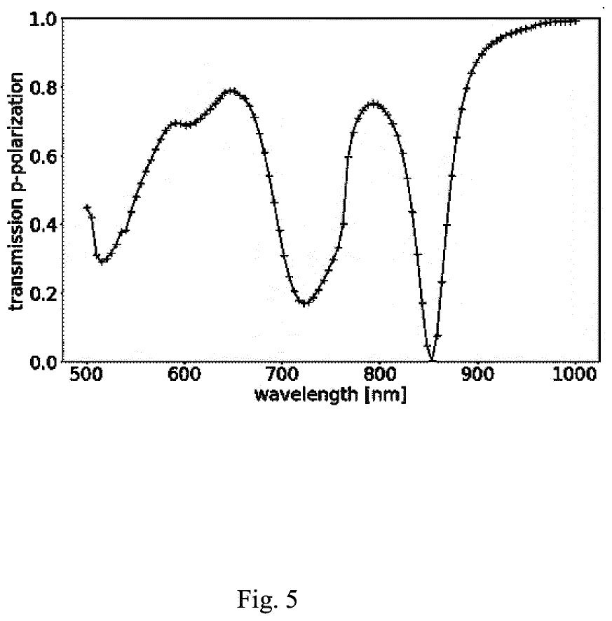

FIG. 5 shows the simulated transmission spectrum of a dielectric amorphous silicon nanodisk metasurface as a comparison to the spectra of the plasmonic metasurface (FIG. 3 and FIG. 4). The nanodisks, arranged in an infinite square lattice on top of a glass substrate, have a diameter of 195 nm, a height of 203 nm and a period of 510 nm.

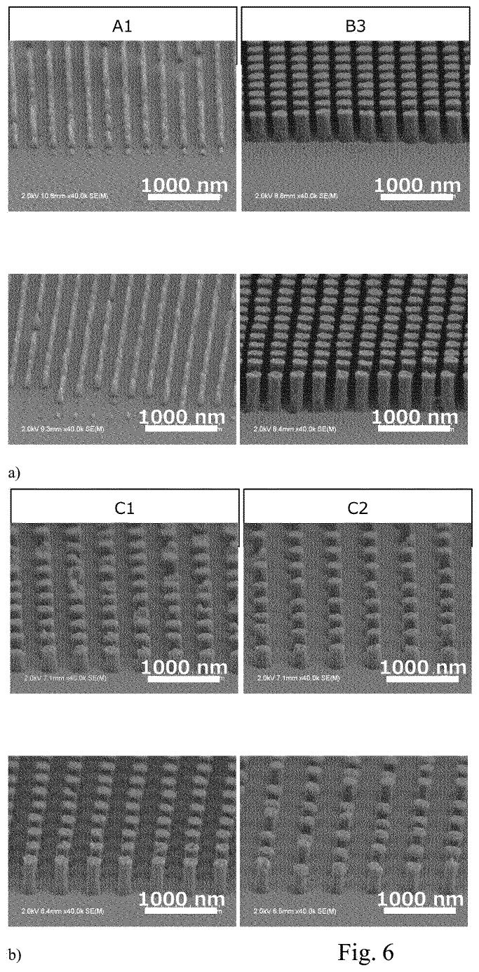

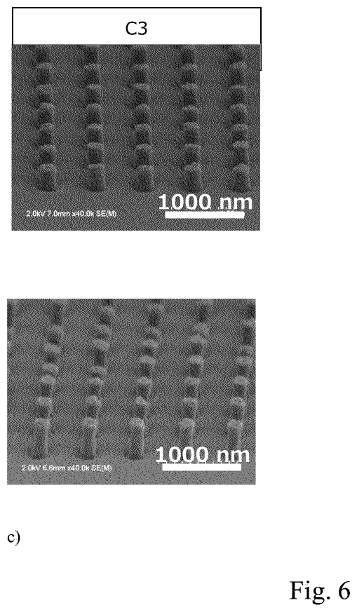

FIGS. 6a, b and c show the results of scanning electron microscopies of suitable injection molded periodic nanostructures. The pictures correspond to the following parameters.

| Cell | A1 | A2 | A3 | B1 | B2 | B3 | C1 | C2 | C3 |
|---|---|---|---|---|---|---|---|---|---|
| Pitch [nm] | 250 | 300 | 450 | 530 | 630 | 300 | 450 | 530 | 630 |
| Diameter | 140 | | | | | 240 | | | |
| [nm] | | | | | | | | | |

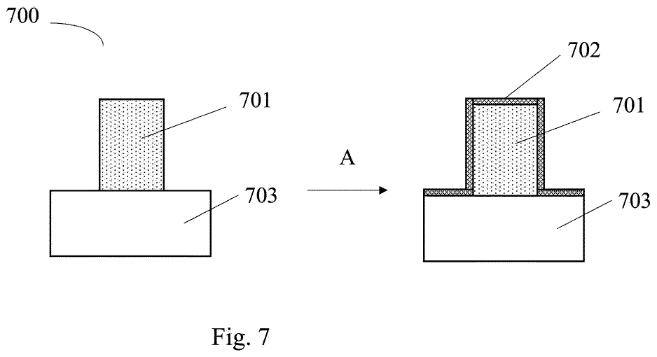

FIG. 7 is a schematic overview of a method for preparing a plasmonic metasurface 700. A nanostructured substrate 703 with a plastic or silica layer 701 is provided. The nanostructured substrate 703 and the plastic or silica layer 701 may be the same material. In step A, the nanostructured substrate 703, here with a disk as geometric pattern, is coated with an ultrathin metal layer 702. Thus, a nanostructured substrate 703 coated with an ultrathin metal layer 702 is obtained.

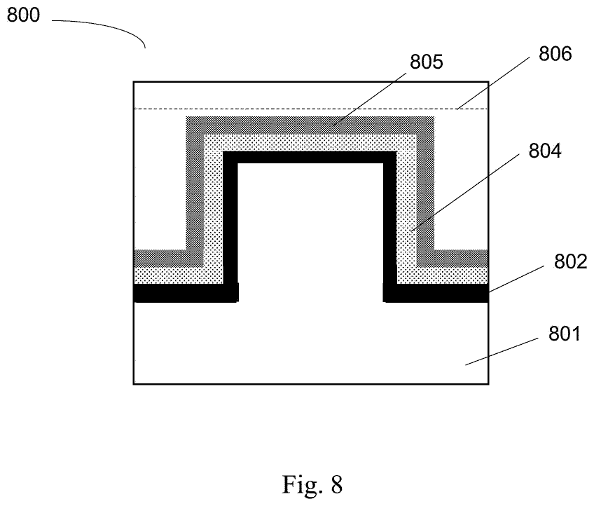

FIG. 8 shows an exemplary embodiment of a metaatom 800. The metaatom 800 comprises a plastic or silica layer 801, a plasmonic metal layer 802, a dielectric component 804 and an emissive system 805. Optionally, the metaatom 800 comprises a planarization 806.

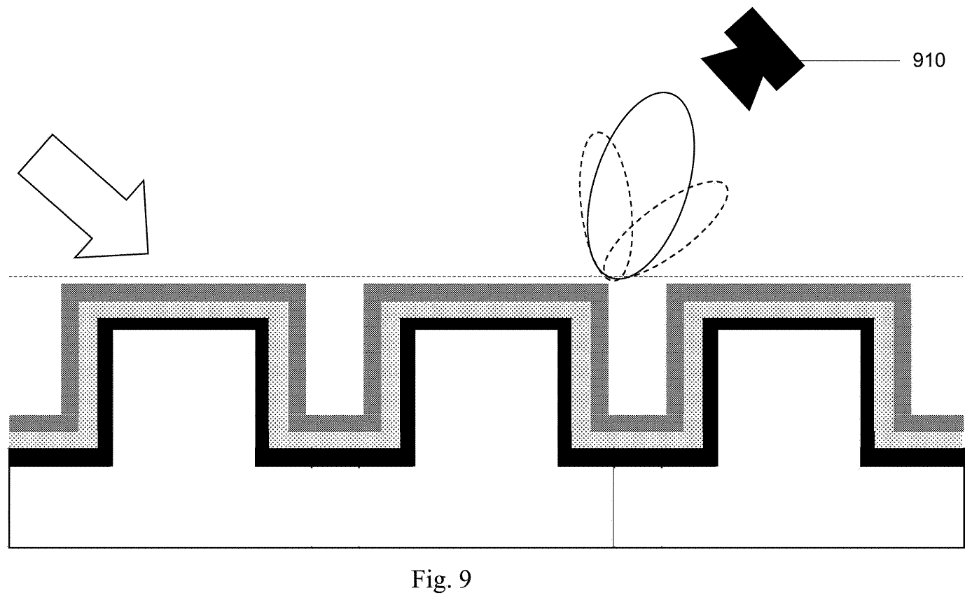

FIG. 9 shows the emission enhancement of an exemplary metasurface in reflection. The arrow represents the excitation and 910 is the detector.

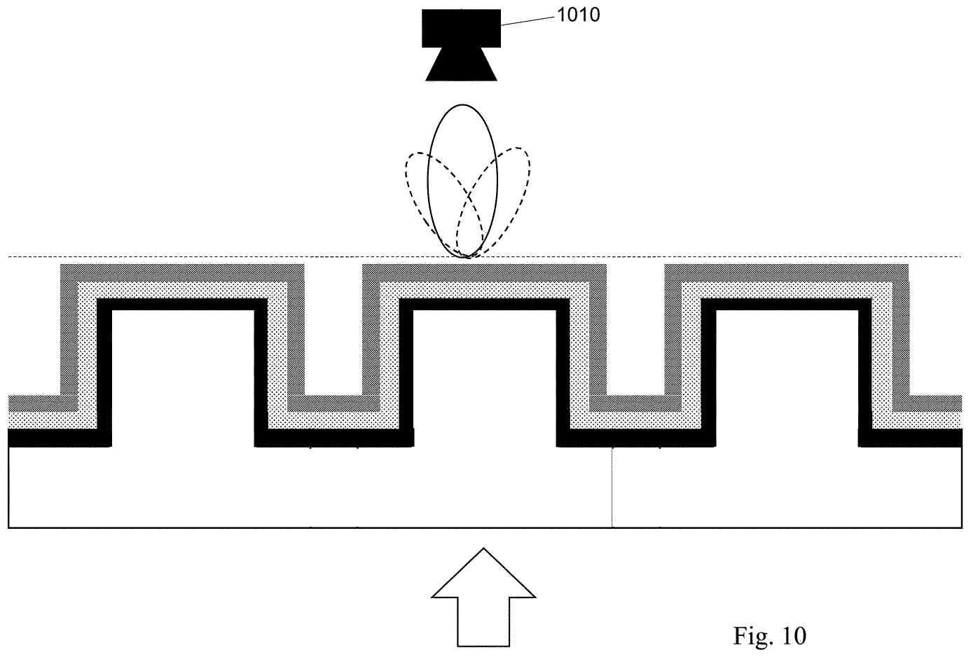

FIG. 10 shows the emission enhancement of an exemplary metasurface in transmission. The arrow represents the excitation and 1010 is the detector.

The embodiments may also comprise:

[1]A plasmonic metasurface comprising a plurality of metaatoms (100, 800), the plasmonic metasurface comprising a nanostructured dielectric component (804) and at least one ultrathin metal layer (102, 702, 802) of one or more plasmonic metals conformal to the nanostructure to define the resonances at designed wavelengths.

[2] The metasurface according to [1], wherein the plasmonic metal layer (102, 702, 802) has a thickness of <50 nm, preferably <15 nm.

[3] The metasurface according to [1] or [2], wherein the plurality of metaatoms (100, 800) are arranged such that they support at least one surface plasmon resonance.

[4] The metasurface according to any of [1] to [3], wherein the plurality of metaatoms (100, 800) are arranged such that they support at least one lattice resonance mode and wherein the metaatoms (100, 800) have a size and shape such that they support at least one surface plasmon resonance.

[5] The metasurface according to any of [1] to [4], wherein the metaatom (100, 800) has an irregular or regular shape.

[6] The metasurface according to any of [1] to [5], wherein the metaatom (100, 800) has a shape selected from cylinders, oval shaped disks, truncated cones or pyramids, semi-spheres, or cuboids, all of them with or without rounded edges

[7] The metasurface according to any of [1] to [6], wherein the one or more plasmonic metals are selected from the group consisting of Ag, Au, Cu, Al, and Ti, and any of their mutual alloys

[8] The metasurface according to any of [1] to [7], further comprising an emissive system (805).

[9] The metasurface according to [8], wherein the nanostructured dielectric component (804) is configured so that a first surface plasmon resonance mode of the metaatoms (100, 800) and a lattice resonance mode of the nanostructured dielectric component (804) are matched to the emission frequency of the emissive system (805), and so that a second surface plasmon resonance mode of the metaatoms (100, 800) is matched to the absorption frequency of the emissive system (805).

[10] The metasurface according to [8] or [9], wherein the nanostructured dielectric component (804), the plasmonic metal layer (102, 702, 802), and the emissive system (805) are configured to resonantly enhance the absorption of the emissive system (805).

[11] The metasurface according to any of [8] to [10], wherein the nanostructured dielectric component (804), the plasmonic metal layer (102, 702, 802), and the emissive system (805) are configured to resonantly enhance the emission of the emissive system (805).

[12] The metasurface according to any of [8] to [11], wherein the plasmonic metasurface is configured for color conversion in the visible spectrum.

[13] The metasurface according to any of [8] to [12], wherein the plasmonic metasurface is configured for directional intensity control of incident and emitted light.

[14] The metasurface according to any of [1] to [13], wherein the plasmonic metal layer (102, 702, 802) is located on top of a plastic or silica layer (101, 701, 801).

[15] The metasurface according to any of [1] to [14], wherein the nanostructured dielectric component (804) comprises a dielectric material having a refractive index between 1.3 to 1.7.

[16] The metasurface according to any of [1] to [15], wherein the nanostructured dielectric component (804) is selected from thermoplastic such as PE (polyethylene), PS (polystyrene), PMMA (poly methyl methacrylate), PC (polycarbonate), COC (cyclic olefin copolymer), PET (polyethylene terephthalate), and Nylons.

[17] The metasurface according to any of [1] to [16], wherein the dimensions of the metaatoms (100, 800) are smaller than half of the freespace wavelength.

[18] The metasurface according to any of [8] to [17], wherein the emissive system (805) is a ternary or higher number of components emissive system (805).

[19] The metasurface according to any of [8] to [18], wherein the emissive component comprises at least one of the following: organic dyes (chromophores as absorbers and fluorophores or phosphors as emitters) as well as inorganic absorbers and emitters including quantum dots.

[20] The metasurface according to any of [8] to [19], wherein the emissive component comprises a combination of organic matrix and inorganic absorbers and/or emitters and other way around—inorganic matrix with organic absorbers/emitters.

[21] The metasurface according to any of [8] to [20], wherein the emissive system (805) comprises at least one component as an emitter and at least one component as an absorber mixed together in a matrix material.

[22] The metasurface according to [21], wherein the absorber and the emitter are two different organic dyes/molecules.

[23] The metasurface according to [21] or [22], wherein the emissive system (905) absorbs and emits in the visible range.

[24] The metasurface according to any of [22] to [23], wherein the emitter and the absorber are selected so that the absorption and emission peaks of the emissive system (805) are tuned to the resonances of the nanostructure.

[25] The metasurface according to any of [22] to [24], wherein, by tuning of the concentrations of the emitter and absorber in the emissive system (805), the efficiency of the energy transfer, the field distribution inside the emissive system (805), are optimized and the loss by reabsorption is diminished.

[26] The metasurface according to any of [1] to [25], wherein the complex refractive index of the emissive system (805) is optimized for best performance of the emissive metasurface.

[27] The metasurface according to any of [1] to [26], wherein the refractive index n=n+ik of the emissive system (805) at absorption wavelength is n=2.0 at k=0.2, and the refractive index n=n+ik of the emissive system (805) at emission wavelength is n=1.8 at k=0.01.

[28]A semiconductor device comprising the metasurface according to any of [1] to [27], the metasurface being configured for enhancement of absorption of a first color and emission of a second color.

[29] The semiconductor device of [28], wherein the first color is blue and second color is red or green.

[30]A method for preparing a metasurface according to any of [1] to [27], the method comprising the steps:
Providing a nanostructured plastic substrate (101, 701, 801) by injection molding or hot embossing,
Optionally, coating the substrate (101, 701, 801) with an adhesion layer,
Coating the substrate with an ultrathin plasmonic metal layer (102, 702, 802)
Optionally, coating the ultrathin metal layer (102, 702, 802) with dielectric layer for protection, spacing, or adhesion purposes

[31] The method according to [30], further comprising the step of applying an emissive system (805) on top of the metal (102, 702, 802) or dielectric layer.

LIST OF REFERNCE SIGNS

| | |
|---|---|
| 100, 800 | metaatom |
| 101, 701, 801 | plastic or silica layer |
| 102, 702, 802 | plasmonic metal layer |
| 103, 703 | substrate |
| 700 | method for preparing a metaatom |
| 804 | dielectric component |
| 805 | emissive system |
| 806 | planarization |
| 9010, 1010 | detector |

1. A plasmonic metasurface comprising a plurality of metaatoms, the plasmonic metasurface comprising a nanostructured dielectric component and at least one ultrathin metal layer of one or more plasmonic metals conformal to the nanostructure to define resonances at designed wavelengths.

2. The metasurface according to claim 1, wherein the plasmonic metal layer has a thickness of <50 nm, preferably <15 nm.

3. The metasurface according to claim 1, wherein the plurality of metaatoms are arranged such that they support at least one surface plasmon resonance.

4. The metasurface according to claim 1, wherein the plurality of metaatoms are arranged such that they support at least one lattice resonance mode and wherein the metaatoms have a size and shape such that they support at least one surface plasmon resonance.

5. The metasurface according to claim 1, wherein the metaatom has an irregular or regular shape.

6. The metasurface according to claim 1, wherein the metaatom has a shape selected from cylinders, oval shaped disks, truncated cones or pyramids, semi-spheres, or cuboids, all of them with or without rounded edges.

7. The metasurface according to claim 1, wherein the one or more plasmonic metals are selected from the group consisting of Ag, Au, Cu, Al, and Ti.

8. The metasurface according to claim 1, further comprising an emissive system.

9. The metasurface according to claim 8, wherein the nanostructured dielectric component is configured so that a first surface plasmon resonance mode of the metaatoms and a lattice resonance mode of the nanostructured dielectric component are matched to the emission frequency of the emissive system, and so that a second surface plasmon resonance mode of the metaatoms is matched to the absorption frequency of the emissive system.

10. The metasurface according to claim 8, wherein the nanostructured dielectric component, the plasmonic metal layer, and the emissive system are configured to resonantly enhance the absorption of the emissive system.

11. The metasurface according to claim 8, wherein the nanostructured dielectric component, the plasmonic metal layer, and the emissive system are configured to resonantly enhance the emission of the emissive system.

12. The metasurface according to claim 8, wherein the plasmonic metasurface is configured for color conversion in the visible spectrum.

13. The metasurface according to claim 8, wherein the plasmonic metasurface is configured for directional intensity control of incident and emitted light.

14. The metasurface according to claim 1, wherein the plasmonic metal layer is located on top of a plastic or silica layer.

15. The metasurface according to claim 1, wherein the nanostructured dielectric component comprises a dielectric material having a refractive index between 1.3 to 1.7.

16. The metasurface according to claim 1, wherein the nanostructured dielectric component is selected from thermoplastic such as PE (polyethylene), PS (polystyrene), PMMA (poly methyl methacrylate), PC (polycarbonate), COC (cyclic olefin copolymer), PET (polyethylene terephthalate), and Nylons.

17. The metasurface according to claim 1, wherein the dimensions of the metaatoms are smaller than half of the freespace wavelength.

18. The metasurface according to claim 8, wherein the emissive system is a ternary or higher order emissive system.

19-30. (canceled)

31. A plasmonic metasurface comprising:
a substrate having a periodic array of dielectric nanostructures with lateral dimensions between 20 nm and 500 nm; and
an ultrathin metal film having a thickness less than 50 nm conformally coating the nanostructures to form hollow plasmonic structures, wherein
the metal film comprises at least one metal selected from Ag, Au, Cu, Al, and Ti, and the conformal coating creates localized surface plasmon resonances at predetermined wavelengths in the visible or infrared spectrum.

32. A plasmonic metasurface comprising:
a molded thermoplastic substrate having a refractive index between 1.3 and 1.7, the substrate comprising
a square lattice array of nanodisk structures with a period less than 500 nm;
an ultrathin silver layer having a thickness between 5 nm and 15 nm conformally deposited on the nanodisk structures; and
an emissive layer disposed on the ultrathin silver layer, wherein
a first surface plasmon resonance of the metasurface is matched to an absorption wavelength of the emissive layer and a second surface plasmon resonance is matched to an emission wavelength of the emissive layer for wavelength conversion.
